(19) United States
(12) Patent Application Publication
(10) Pub. No.: US 2022/0153570 A1
(43) Pub. Date: May 19, 2022

(54) Method and Apparatus for a Child's Saddle

(71) Applicants: Roger Williams, Laurel, MT (US); Gypsy Williams Holman, Laurel, MT (US)

(72) Inventors: Roger Williams, Laurel, MT (US); Gypsy Williams Holman, Laurel, MT (US)

(21) Appl. No.: 17/530,327

(22) Filed: Nov. 18, 2021

Related U.S. Application Data
(60) Provisional application No. 63/115,801, filed on Nov. 19, 2020.

(51) Int. Cl. B68C 1/02

(52) U.S. Cl. CPC B68C 1/027; B68C 3/00

(57) ABSTRACT

An apparatus configured for use with a saddle while that saddle is secured to an animal. In a typical application setting, the saddle will include a horn. The apparatus can comprise a main body having a top portion and a bottom portion, the bottom portion being configured to receive the aforementioned horn of the saddle. The apparatus can also comprise a securement mechanism configured to selectively and temporarily secure the main body to the saddle while the saddle is secured to the animal.

### RELATED APPLICATION(S)

This application claims the benefit of U.S. Provisional application No. 63/115,801, filed Nov. 19, 2020, which is incorporated by reference in its entirety herein.

### TECHNICAL FIELD

These teachings relate generally to saddles.

### BACKGROUND

Saddles are known in the art. Generally speaking, a saddle is a supportive structure that fastens to the back of an animal such as a horse. More particularly, the saddle serves to provide a place to receive a seated human rider in relative safety and comfort. Saddles are ordinarily sized to accommodate adults and older children.

Younger children (such as children under 5 years of age) are often too small to properly use a typical saddle. Furthermore, it may be inappropriate to permit a young child to sit unaccompanied on an animal. In some cases, an adult rider will share a saddle with a child by placing the child in front of them on the saddle. In other cases, child-accommodating structures have been proposed that permit a young child to be seated behind the adult rider. For a variety of reasons, the foregoing solutions may not meet all requirements and/or preferences of the supervising adult.

### BRIEF DESCRIPTION OF THE DRAWINGS

The above needs are at least partially met through provision of the method and apparatus for a child's saddle described in the following detailed description, particularly when studied in conjunction with the drawings, wherein:

FIG. 1 comprises a flow diagram as configured in accordance with various embodiments of these teachings;

FIG. 2 comprises a perspective view as configured in accordance with various embodiments of these teachings;

FIG. 3 comprises a side elevational view as configured in accordance with the prior art;

FIG. 4 comprises a rear elevational view as configured in accordance with the prior art;

FIG. 5 comprises a side elevational view as configured in accordance with various embodiments of these teachings;

FIG. 6 comprises a rear elevational view as configured in accordance with various embodiments of these teachings; and

FIG. 7 comprises a perspective view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments provide for an apparatus configured for use with a saddle while the saddle is secured to an animal. In a typical application setting, the saddle will include a horn. The apparatus can comprise a main body having a top portion and a bottom portion, the bottom portion being configured to receive the aforementioned horn of the saddle. The apparatus can also comprise a securement mechanism configured to selectively and temporarily secure the main body to the saddle while the saddle is secured to the animal.

By one approach, the aforementioned bottom portion of the main body comprises an open portion formed therein. The top portion can comprise a curved surface.

So configured, the apparatus can be disposed atop a saddle such that the bottom portion receives the horn of the saddle. A first part of the aforementioned securement mechanism can be disposed underneath a swell of the saddle and then secured to a second part of the securement mechanism to thereby secure the apparatus to the saddle. A child can then be placed atop the apparatus while an adult rider is seated in the saddle, such that the child faces away from the adult rider and towards the front of the animal.

These teachings are highly practical and flexible in practice and will accommodate various modifications and/or supplemental features. As one example, the apparatus can include stirrups that attach to the main body. These stirrups can receive the feet of a child seated atop the apparatus. As another example, the apparatus can include a handle that extends outwardly from the top portion, such that a child seated atop the apparatus can grasp the handle with one or both hands to increase their comfort level and to better facilitate their own stability while so seated.

The aforementioned body can assume any of a wide variety of form factors. By one approach, the main body can comprise, at least in part, a hollow half cylinder. By another approach, however, the main body can replicate, at least in many respects, the shape and/or features of an ordinary saddle.

These teachings provide a way of permitting a child to ride an animal with an adult that offers increased safety and comfort for both the child and the adult rider.

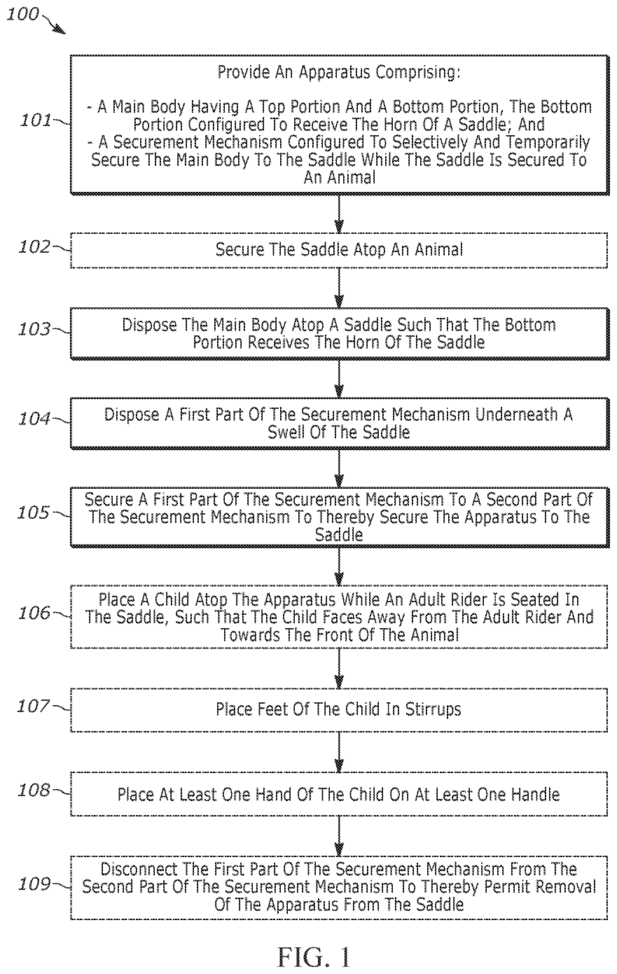

These and other benefits may become clearer upon making a thorough review and study of the following detailed description. Referring now to the drawings, and in particular to FIG. 1, an illustrative process 100 that is compatible with many of these teachings will be presented.

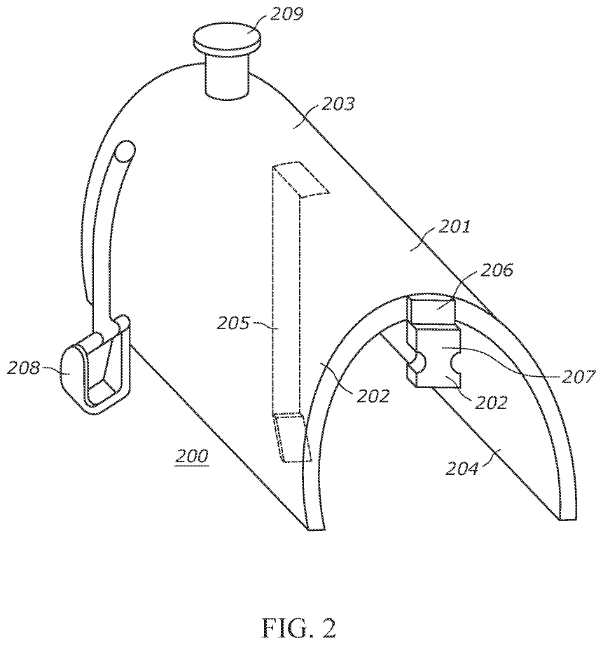

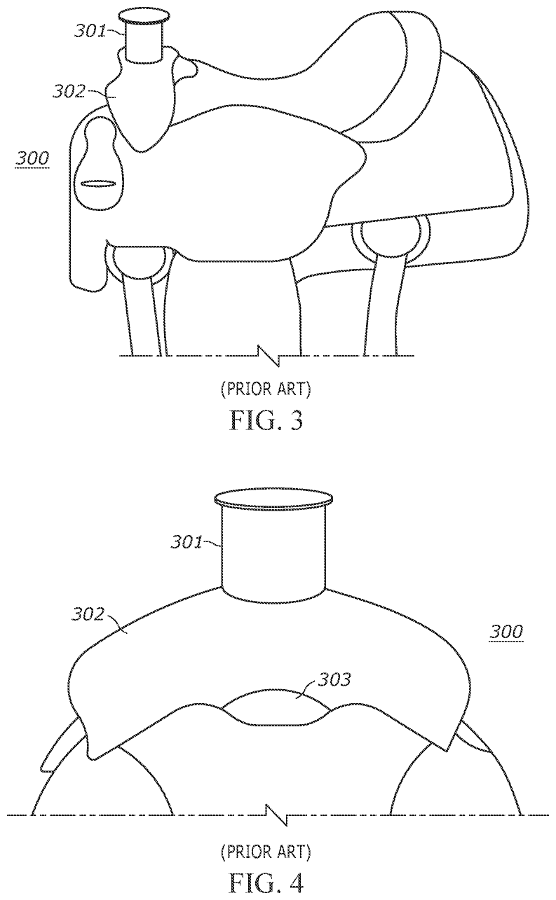

With reference to block 101, and referring as well to FIG. 2, this process provides an apparatus 200 configured to use with a saddle while the saddle is secured to an animal. Referring momentarily to FIGS. 3 and 4, that saddle 300 may comprise a so-called Western saddle having a horn 301 that is disposed atop a portion of the saddle 300 referred to as the swell 302. As is typical of such a saddle, and as best shown in FIG. 4, there is an opening 303 disposed front-to-back underneath the swell 302. Aside from these basic features, these teachings are highly flexible in practice and will accommodate a wide variety of differently configured and differently purposed saddles.

With continued reference to FIGS. 1 and 2, the provided apparatus 200 comprises a main body 201 and a securement mechanism 202.

The main body 201 has a top portion 203 and a bottom portion 204. The main body 201 may be comprised of any suitable material including, for example, resilient plastic. Generally speaking, the dimensions of this main body 201 are selected to accommodate the physical dimensions of an average human child of ages 1 to 4. By one approach, the main body 201 may have a length in the range of 7 inches to 10 inches, such as 8.5 inches. The height of the main body 201 may be in the range of 3.5 inches to 5.5 inches, such as 4.5 inches. And the width of the main body 201, at its widest point, may be in the range of 7 inches to 9 inches, such as 8 inches.

The top portion 201 in this illustrative example comprises a curved surface, and in particular, a half-cylinder. If desired, portions of the main body may be contoured to better accommodate corresponding contours in the aforementioned saddle 300. If desired, part or all of the top portion 203 may be covered with a material such as fabric or leather. Padding may also be utilized and/or a seat may be affixed to that top portion 203 to accommodate a child.

The bottom portion 204 is configured to receive the aforementioned saddle horn 301. In particular, the bottom portion 204 can comprise an open portion that is formed in the main body 201 and that can receive the aforementioned saddle horn 301. In this illustrative example, the bottom portion 204 is not conformally shaped to specifically accommodate the horn 301. If desired, however, the bottom portion 204 can be configured to include a horn-receiving opening that is more specific to the dimensions of a specific or a typical horn.

The aforementioned securement mechanism 202 is configured to selectively and temporarily secure the main body 201 to the saddle 300 while the saddle 300 is secured to an animal. (For the sake of an illustrative example, this description presumes that the animal comprises a member of the horse family such as a horse, donkey, or mule. It will be understood, however, that these teachings are not limited in those regards.)

In this example, the securement mechanism comprises a first strap 205 that is secured at one end to the main body 201 and that is configured to be disposed underneath the swell 302 of the saddle 300 (for example, by placing the first strap 205 through the aforementioned opening 303 beneath the swell 302). In this illustrative example, the securement mechanism 202 also comprises a second strap 206 that is secured at one end to the main body 201 and that has an unattached end 207 that is configured to attach to the first strap 205.

The aforementioned attachment can be achieved using any of a variety of attachment mechanisms including a variety of buckles, snap fits, and so forth. The straps can be comprised, for example, of nylon, leather, or other suitable material. In this illustrative example the two straps are discrete from one another. If desired, however, these two elements can be joined to form one continuous strap that itself is secured to the main body 201.

These teachings will accommodate a variety of modifications and/or supplemental features as desired. As one example, these teachings will accommodate attaching stirrups 208 to the main body 201. As another example, in lieu of the foregoing or in combination therewith, these teachings will accommodate disposing a handle 209 on the main body 201. By one approach, this handle extends outwardly from the top portion 203 and is disposed forwardly when the apparatus 200 is deployed on the saddle 300 as described below. In this illustrative example, the handle 209 has the form factor of a saddle horn. These teachings will accommodate other form factors in these regards, however, including, for example, any of a variety of handle bars.

So configured, those skilled in the art will perceive and appreciate that the aforementioned apparatus 200 itself in effect comprises and serves as a small saddle that will accommodate a young child. In this case, however, this small saddle secures to a larger saddle rather than directly to the animal itself.

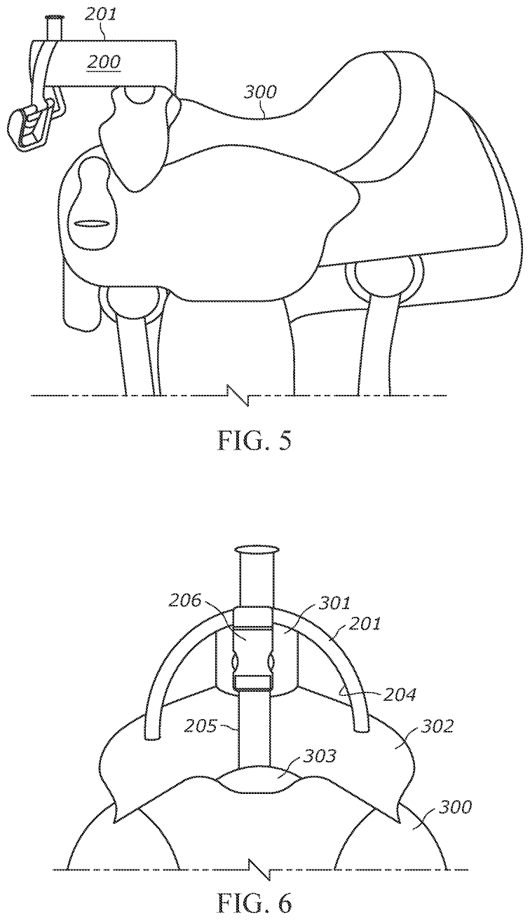

At block 102, this process 100 provides for optionally securing the aforementioned saddle 300 atop an animal such as a horse. At block 103, and with reference to FIGS. 5 and 6, this process 100 provides for disposing the main body 201 atop that saddle 300 such that the bottom portion 204 receives the horn 301 of the saddle 300. At block 104, the first part 205 of the securement mechanism 202 is disposed underneath the swell 302 (and through the aforementioned opening 303) of the saddle 300, and at block 105 the first part 206 of the securement mechanism 202 is secured to the opposing part of the securement mechanism to thereby secure the apparatus 202 the saddle 300. The securement mechanism strap can then be tightened in a manner corresponding to the particular attachment mechanism being utilized. Once secured and tightened in this way, the main body 201, serving as a child's saddle, is thereby temporarily secured to the saddle 300.

As used herein, the term “temporarily” will be understood to refer to an anticipated usage timeframe that is considerably less than the operating lifetime of the equipment itself and to an application setting where the apparatus 200 is designed to be readily installed by a user to support momentary use and to be readily removed by the user upon concluding that momentary use. This is not to say, however, that a given user could not choose to leave the apparatus 200 in its installed position for an extended period of time. Headphones are an illustrative example in these regards in that the headphones are properly viewed as being temporarily attached to an audio playback device via a corresponding jack connector notwithstanding that a given user might leave the headphones so connected for a long period of time.

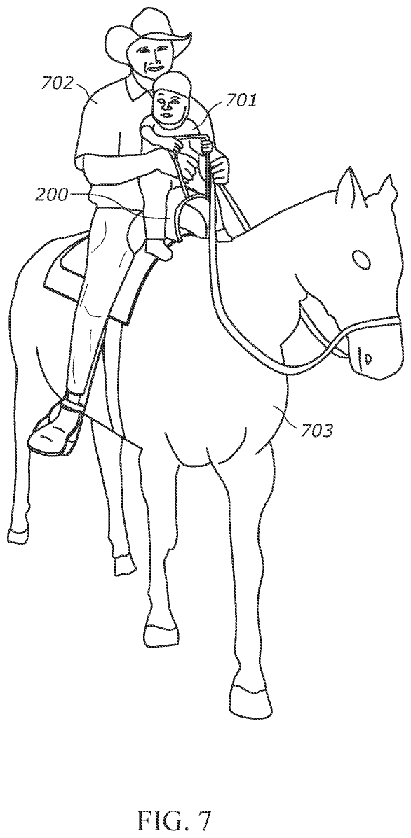

With continued reference to FIG. 1, and referring now as well to FIG. 7, at optional block 106 this process 100 accommodates placing a child 701 atop the apparatus 200 while an adult rider 702 is seated in the saddle 300, such that the child 701 faces away from the adult rider and towards the front of the animal 703. When the apparatus 200 includes the aforementioned stirrups 208, at optional block 107 the child's feet may be placed in those stirrups 208. At optional block 108, at least one hand of the child is placed on the handle that comprises a part of the apparatus 200. (In FIG. 7, the handle comprises a handlebar form factor as versus the horn-like form factor presented in earlier figures.)

So mounted, the adult rider 702 may then control movement of the animal 703 while the child 701 sits astride the apparatus 200. Those skilled in the art will appreciate that this configuration permits the adult rider 702 to help hold the child 701 in place with one hand/arm while riding.

Upon concluding a ride and dismounting the child from the apparatus 200, at optional block 109 the aforementioned parts of the securement mechanism 202 may be disconnected and the apparatus 200 readily removed from the saddle 300 by disengaging the apparatus 200 from the saddle's horn 301.

These teachings provide an apparatus and approach to having a child join an adult rider for a mounted ride on an animal that offers improved convenience, comfort, and safety. These teachings can be implemented in a highly cost-effective manner and using any of a wide variety of materials, form factors, and aesthetic features.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. An apparatus configured for use with a saddle while the saddle is secured to an animal, the saddle having a horn, the apparatus comprising:
a main body having a top portion and a bottom portion, the bottom portion configured to receive the horn of the saddle;
a securement mechanism configured to selectively and temporarily secure the main body to the saddle while the saddle is secured to the animal.

2. The apparatus of claim 1 wherein the animal comprises a member of the horse family.

3. The apparatus of claim 1 wherein the bottom portion comprises an open portion formed in the main body.

4. The apparatus of claim 1 wherein the top portion comprises a curved surface.

5. The apparatus of claim 1 wherein the securement mechanism comprises, at least in part, a first strap that is secured at one end to the main body and that is configured to be disposed underneath a swell of the saddle.

6. The apparatus of claim 5 wherein the securement mechanism further comprises, at least in part, a second strap that is secured at one end to the main body and having an unattached end that is configured to attach to the first strap.

7. The apparatus of claim 1 wherein the apparatus comprises a saddle.

8. The apparatus of claim 1 further comprising:
stirrups attached to the main body.

9. The apparatus of claim 1 further comprising:
a handle disposed on the main body and extending outwardly from the top portion, wherein the handle is disposed forwardly when the apparatuis deployed on the saddle.

10. A method to secure an apparatus to a saddle having a horn, the method comprising:
providing an apparatus comprising:
a main body having a top portion and a bottom portion, the bottom portion configured to receive the horn of the saddle; and
a securement mechanism configured to selectively and temporarily secure the main body to the saddle while the saddle is secured to the animal;
disposing the main body atop the saddle such that the bottom portion receives the horn of the saddle;
disposing a first part of the securement mechanism underneath a swell of the saddle;
securing the first part of the securement mechanism to a second part of the securement mechanism to thereby secure the apparatus to the saddle.

11. The method of claim 10 further comprising, before disposing the main body atop the saddle:
securing the saddle atop an animal.

12. The method of claim 11 wherein the animal comprises a member of the horse family.

13. The method of claim 11 wherein the apparatus comprises a child-size saddle.

14. The method of claim 13 further comprising:
placing a child atop the child-size saddle while an adult rider is seated in the saddle, such that the child faces away from the adult rider and towards the front of the animal.

15. The method of claim 14 wherein the child-size saddle further includes stirrups and wherein the method further comprises:
placing feet of the child in the stirrups.

16. The method of claim 14 wherein the child-size saddle further includes at least one handle mounted forwardly of the child-size saddle, and wherein the method further comprises:
placing at least one hand of the child on the at least one handle.

17. The method of claim 10 wherein securing the first part of the securement mechanism to a second part of the securement mechanism to thereby secure the apparatus to the saddle comprises tightly securing the apparatus to the saddle.

18. The method of claim 10 further comprising:
disconnecting the first part of the securement mechanism from the second part of the securement mechanism to thereby permit removal of the apparatus from the saddle.
